(19) United States
(12) Patent Application Publication
(10) Pub. No.: US 2025/0182726 A1
(43) Pub. Date: Jun. 5, 2025

(54) GENERATING TARGET MUSIC USING MACHINE LEARNING MODEL

(71) Applicant: Lemon Inc., Grand Cayman (KY)

(72) Inventors: Julian Parker, London (GB); Janne Jayne Harm Renee Spijkervet, London (GB); Duc Le, Los Angeles, CA (US)

(21) Appl. No.: 18/529,608

(22) Filed: Dec. 5, 2023

(51) Int. Cl. G10H 1/00; G06F 40/40; G06N 3/0455; G06N 3/0475

(52) U.S. Cl. CPC G10H 1/0025; G06F 40/40; G06N 3/0455; G06N 3/0475; G10H 2210/115; G10H 2210/125

(57) ABSTRACT

The present disclosure describes techniques for generating target music. Audio and text are input to a machine learning model. The audio indicates a context of the target music, and the text specifies one or more musical instruments of the target music. A representation of the target music is generated through an iterative process. The target music features the one or more musical instruments specified by the text and aligns with the audio. The iterative process comprises a plurality of iterations. Each iteration comprises employing a multi-source classifier-free guidance mechanism to sample logits output from a previous iteration. The multi-source classifier-free guidance mechanism is configured to separately weight influences of the audio and the text. Each iteration comprises ranking the sampled logits based at least in part on a timeline of the target music. Each iteration comprises updating the representation of the target music based on the ranked sampled logits.

### BACKGROUND

Machine learning models are increasingly being used across a variety of industries to perform a variety of different tasks. Such tasks may include audio-related tasks. Improved techniques for utilizing machine learning models for audio-related tasks are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for generating target music using a machine learning model in accordance with the present disclosure.

FIG. 2 shows an example system for generating continuous embeddings in accordance with the present disclosure.

FIG. 3 shows an example system for training a machine learning model to generate target music in accordance with the present disclosure.

FIG. 4 shows an example system for generating pairs of training data in accordance with the present disclosure.

FIG. 5 shows an example process for generating target music using a machine learning model in accordance with the present disclosure.

FIG. 6 shows an example process for generating target music using a machine learning model in accordance with the present disclosure.

FIG. 7 shows an example process for generating target music using a machine learning model in accordance with the present disclosure.

FIG. 8 shows an example process for generating target music using a machine learning model in accordance with the present disclosure.

FIG. 9 shows an example process for process for generating context-text embeddings in accordance with the present disclosure.

FIG. 10 shows an example process for process for generating target-text embeddings in accordance with the present disclosure.

FIG. 11 shows an example process for process for generating continuous embeddings in accordance with the present disclosure.

FIG. 12 shows an example process for process for training a machine learning model to generate target music in accordance with the present disclosure.

FIG. 13 shows an example process for process for generating pairs of training data in accordance with the present disclosure.

FIG. 14 shows an example process for process for training a machine learning model to generate target music in accordance with the present disclosure.

FIGS. 15A, 15B, 16A, 16B show results of evaluating performance of a machine learning model in accordance with the present disclosure.

FIG. 17 shows an example computing device which may be used to perform any of the techniques disclosed herein.

### DETAILED DESCRIPTION OF ILLUSTRATIVE EMBODIMENTS

End-to-end generation of musical audio using deep learning techniques is a fairly new discipline. Recent work has shown a large jump in the quality and diversity of generated music by borrowing techniques from the image and language processing fields. Some approaches operate on tokenized audio representations using techniques from the large language model (LLM) literature, while other approaches use score-matching techniques to generate audio directly or encoded as a continuous latent representation.

Music can generally be thought of as the sum of a number of independent but strongly related individual parts, conceived at different levels of elaboration and textural layout which are combined together to produce a full piece of music. A part may correspond to a musician playing, a particular instrument, or to something more abstract like the output of a sampler or synthesizer. These parts are often colloquially referred to as stems. Music production can be thought of as an iterative procedure that seeks to add and refine these stems to fit the aesthetic preferences of the producer or musician. For example, in a first iteration, a stem corresponding to a piano playing may be added to a piece of context audio. The context audio may be, for example, a vocal recording or a recording of a guitar playing. Then, in a second iteration, a stem corresponding to drums playing may be added to the piano-context audio mix. Additional stems may be added during additional iterations to produce the final piece of music.

In order for the final piece of music to sound coherent, each of the added stems must be constructed to be sympathetic with the context of the existing composition, both musically and texturally. A generative model that performs this task is therefore a desirable tool for those making music. Such a generative model could support existing music production workflows instead of supplanting them. However, the majority of existing generative models for musical audio are conditioned on relatively abstract information, varying from text descriptions to style categories. As such, these existing generative models cannot be used directly for this iterative composition approach.

Described herein is an end-to-end generative model that is able to listen to a musical context and generate an appropriate response. The architecture of the end-to-end generative model described herein is based on a non-autoregressive language model with a transformer backbone. The end-to-end generative model described herein utilizes two novel improvements to audio generation: a multi-source classifier-free guidance (CFG), and causal-bias during iterative decoding. The end-to-end generative model is trained on two datasets of stem-based musical audio, and was evaluated using standard objective metrics, a novel evaluation approach using an amalgamation of music information retrieval (MIR) metrics and listening tests.

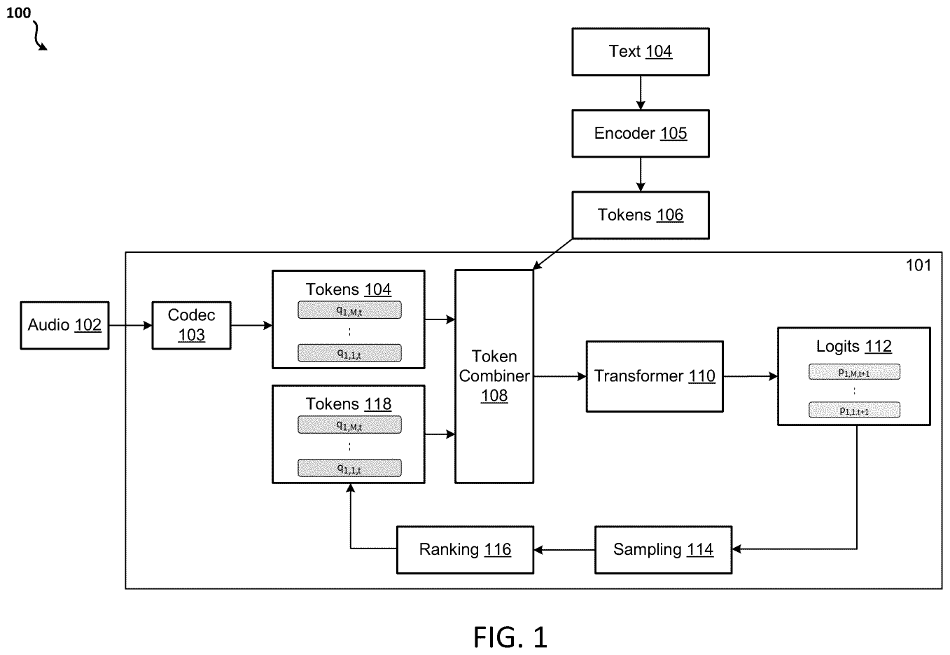

FIG. 1 illustrates an example system 100 in accordance with the present disclosure. The system 100 may comprise a machine learning model 101. The machine learning model 101 may be configured to generate target audio. Audio 102 may be input into (e.g., received by) the machine learning model 101. The audio 102 may indicate a context of the target music to be generated. For example, the audio 102 may comprise audio of a guitar playing (or any other instrument playing or vocal performance). Text 104 may be input into (e.g., received by) the machine learning model 101. The text 104 may specify one or more musical instruments of the target music to be generated. For example, the text 104 may specify that the target music should include audio of a piano playing (or any other instrument playing or vocal performance). Additionally, or alternatively, the text 104 may specify one or more of a genre, a tempo, a style, a melody, a rhythm, a pitch, or any other characteristic of the desired target music.

The machine learning model 101 may utilize the input audio 102 and the input text 104 to generate target music that features the one or more musical instruments specified by the input text 104 and aligns with (e.g., corresponds to) the input audio 102. For example, if the input audio 102 comprises audio of a guitar playing and the input text 104 specifies that the target music should include audio of a piano playing, the machine learning model 101 may utilize the input audio 102 and the input text 104 to generate target music that features a piano playing and that aligns with (e.g., corresponds to) the guitar playing.

The machine learning model 101 may generate a representation of the input audio 102. The representation of the input audio 102 may comprise tokens 104. The tokens 104 may be, for example, a sequence of integer numbers. The representation of the input audio 102 may be generated using a codec 103. The codec 103 may be configured to generate the representation of the input audio 102 by compressing the input audio 102 into the tokens 104. The machine learning model 101 may generate a representation of the input text 104. The representation of the input text 104 may comprise tokens 106. The tokens 106 may be, for example, a sequence of integer numbers. The representation of the input text 104 may be generated using an encoder 105. The encoder 105 may be configured to generate the representation of the input text 104 by compressing the input text 104 into the tokens 106.

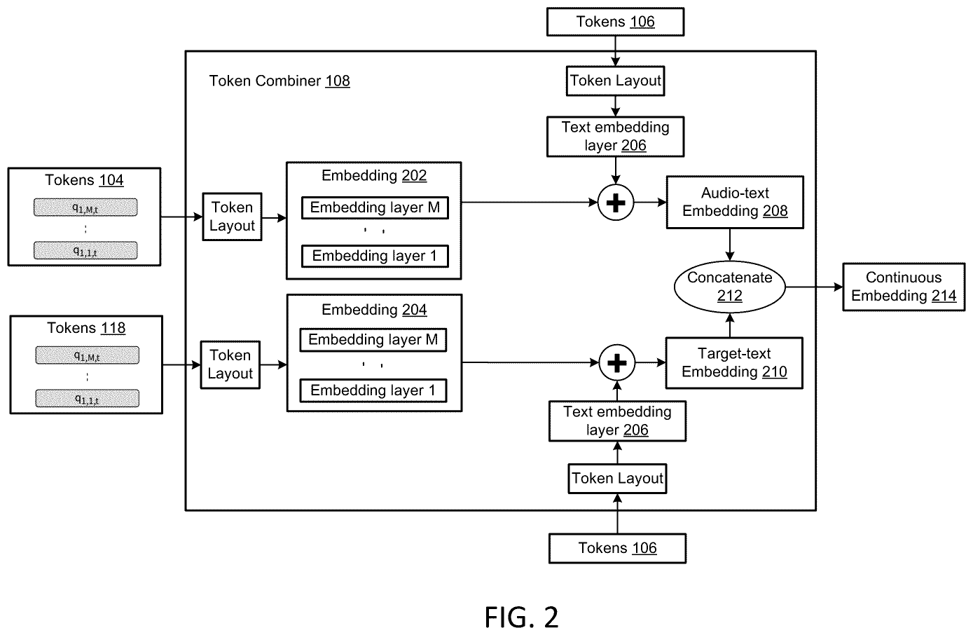

The machine learning model may generate the target music that features the one or more musical instruments specified by the input text 104 and aligns with (e.g., corresponds to) the input audio 102 using an iterative process. In examples, for the first iteration, the representation of the input audio 102 and the representation of the input text 104 may be input into (e.g., received by) a token combiner 108. The token combiner 108 may be configured to combine multiple channels of information (e.g., the representation of the input audio 102 and the representation of the input text 104) to generate a continuous embedding (e.g., a set of floating point numbers). The token combiner 108 is discussed in more detail below with regard to FIG. 2. The continuous embedding is input into (e.g., received by) a transformer sub-model 110. The transformer sub-model 110 may receive the continuous embedding from the token combiner 108. The transformer sub-model 110 may generate an initial set of logits 112 based on (e.g., using) the continuous embedding. The logits 112 may comprise predictions of what the machine learning model 101 determines is in each spot of the target music that is being generated.

The initial set of logits 112 may be sampled by employing a sampling mechanism 114. The sampling mechanism 114 may be, for example, a multi-source CFG mechanism. CFG is a mechanism that allows for the amplification of the effect (e.g., influence) of some external conditioning information on the output of a network. However, unlike existing formulations of CFG that only allow for the amplification of the effect (e.g., influence) of one type of external conditioning information on the output of a network, the multi-source CFG mechanism used to sample the logits 112 allows for the amplification of the effect (e.g., influence) of multiple types of external conditioning information on the output of a network. For example, the multi-source CFG mechanism may be configured to separately weight the influences of the input audio 102 and the input text 104 on the target music that is being generated. The following formula may be used for independently weighting the guidance for the input audio 102 and the input text 104:

$$log p ( t ) {\prod }_{i = 1}^{N} {( {c}_{i} \vert t )}^{{λ}_{i}} \approx {\sum }_{i = 1}^{N} {λ}_{i} log ( p ( t \vert {c}_{i} ) + ( 1 - {\sum }_{i = 0}^{N} {λ}_{i} ) log ( p ( t ) )$$

where the cᵢ are independent conditioning sources, and λᵢ are the guidance scales for each conditioning source. The derivation follows from that of single-source classifier-free guidance, via the application of Bayes' rule. To support this multi-source classifier-free guidance, it is necessary to train the model with independent dropout for each conditioning source. The multi-source CFG can be applied over both conditioning sources simultaneously using the formulation:

$$log ( p ( t ) p ( c \vert t ) λ \approx λlog ( p ( t \vert c ) ) + ( 1 - λ ) log ( p ( t ) )$$

where c is a combined conditioning source containing both the context-mix and any other conditioning and λ is the guidance scale.

Depending on the separate weights assigned to the input audio 102 and the input text 104, either the strength of the influence of the input audio 102 or the strength of the influence of the input text 104 may be used to dominate the generation of the target music. For example, if the input audio 102 is assigned a greater weight than the input text 104, the input audio 102 may dominate the generation of the target music. If the input audio 102 dominates the generation of the target music, the target music will closely align with the input audio 102 but may or may not feature the instruments specified in the input text 104. Conversely, if the input text 104 is assigned a greater weight than the input audio 102, the input text 104 may dominate the generation of the target music. If the input text 104 dominates the generation of the target music, the target music will feature the instruments specified in the input text 104 but may or may not align well with the input audio 102.

The sampled logits may be ranked using a ranking sub-model 116. The ranking sub-model 116 may rank the sampled logits using causal-bias during iterative decoding. The ranking sub-model 116 may ranking the sampled logits using one or more criteria. The ranked and sampled logits may be used to generate an initial representation of the target music. The initial representation of the target music may comprise tokens 118. The tokens 118 may be, for example, a sequence of integer numbers.

The criteria used to rank the sampled logits has a strong effect on the quality of generated output. A first criteria may rank the sampled logits by the confidence of the machine learning model 101, as indicated by the confidence value of each sampled logit. A second criteria may randomly select the sampled logits, such as by adding Gumbel noise to the confidence rankings with a defined weighting. However, biasing the generation towards confidence leads to monotonous and uninteresting output, whereas relying too heavily on random selection leads to poor transients and unnatural amplitude fluttering in the output. Thus, a third criteria, which encourages earlier sequence elements to be sampled first, may be used to rank the sampled logits. Using the third criteria to rank the sampled logits may enforce a kind of fuzzy causality. The third criteria may be used alone, or in combination with the first and/or second criteria, to rank the sampled logits. For example, the following ranking function, which incorporates the first, second, and third criteria, may be used:

$$ρ ( {x}_{n} ) = {w}_{c} \cdot c ( {x}_{n} ) + {w}_{s} \cdot ( 1 - n / N ) + {w}_{r} X$$

where xₙ is a sampled logit at sequence index n, N is the total sequence length, c(xₙ) is the model's confidence in the sampled logit as calculated by applying softmax to the logits, X˜U (0,1) is a uniformly distributed random variable, and w_{c}, wₛ, and wᵣ are scalar weights.

For the second iteration, the representation of the input audio 102, the representation of the input text 104, and the initial representation of the target music may be input into (e.g., received by) the token combiner 108. The token combiner 108 may be configured to combine multiple channels of audio information (e.g., the representation of the input audio 102, the representation of the input text 104, and the initial representation of the target music) to generate a continuous embedding (e.g., a set of floating point numbers). The continuous embedding is input into (e.g., received by) the transformer sub-model 110. The transformer sub-model 110 may receive the continuous embedding from the token combiner 108. The transformer sub-model 110 may generate an updated (e.g., second) set of logits 112 based on (e.g., using) the continuous embedding. The second set of logits 112 may comprise predictions of which tokens the machine learning model 101 determines are in each spot in the target music that is being generated.

The second set of logits 112 may be sampled by employing the sampling mechanism 114. As described above, the sampling mechanism 114 may be, for example, a multi-source CFG mechanism. The multi-source CFG mechanism may be configured to separately weight the influences of the input audio 102 and the input text 104 on the target music that is being generated. The sampled logits from the second set of logits 112 may be ranked. The sampled logits from the second set of logits 112 may be ranked using causal-bias during iterative decoding. For example, ranking the sampled logits from the second set of logits 112 using causal-bias during iterative decoding may comprise ranking the sampled logits from the second set of logits 112 using the one or more criteria described above (e.g., confidence, random selection, and/or earlier sequence elements). The ranked and sampled logits may be used to generate an updated (e.g., second) second representation of the target music. For example, the second representation of the target music may comprise updated tokens 118.

During a third iteration, the representation of the input audio 102, the representation of the input text 104, and the second representation of the target music may be input into (e.g., received by) the token combiner 108. The token combiner 108 may be configured to combine multiple channels of audio information (e.g., the representation of the input audio 102, the representation of the input text 104, and the second representation of the target music) to generate a continuous embedding (e.g., a set of floating point numbers). The continuous embedding is input into (e.g., received by) the transformer sub-model 110. The transformer sub-model 110 may receive the continuous embedding from the token combiner 108. The transformer sub-model 110 may generate a further updated (e.g., third) set of logits 112 based on (e.g., using) the continuous embedding. The third set of logits 112 may comprise predictions of which tokens the machine learning model 101 thinks are in each spot in the target music that is being generated.

The third set of logits 112 may be sampled by employing the sampling mechanism 114. As described above, the sampling mechanism 114 may be, for example, a multi-source CFG mechanism. The multi-source CFG mechanism may be configured to separately weight the influences of the input audio 102 and the input text 104 on the target music that is being generated. The sampled logits from the third set of logits 112 may be ranked. The sampled logits from the third set of logits 112 may be ranked using causal-bias during iterative decoding. For example, ranking the sampled logits from the third set of logits 112 using causal-bias during iterative decoding may comprise ranking the sampled logits from the third set of logits 112 using the one or more criteria described above (e.g., confidence, random selection, and/or earlier sequence elements). The ranked and sampled logits may be used to generate a further updated (e.g., third) second representation of the target music. For example, the third representation of the target music may comprise further updated tokens 118.

Any number of additional iterations may be performed. For example, five, ten, twenty, etc. iterations may be performed until a final representation of the target music (e.g., a final set of tokens 118) are generated. The target music may be constructed (e.g., synthesized, generated, etc.) based on the final representation of the target music. For example, the target music may be constructed by inputting the final set of tokens 118 into a decoder that receives the final set of tokens 118 and uses them to construct the audio waveform associated with the target music.

FIG. 2 shows the token combiner 108 in more detail. As described above, the token combiner 108 may be configured to combine multiple channels of audio information to generate a continuous embedding (e.g., a set of floating point numbers). The token combiner 108 may receive, as input, the tokens 104 associated with the audio 102. The token combiner 108 may receive, as input the tokens 106 associated with the text 104. The token combiner 108 may receive, as input the tokens 118 associated with the target music. The token combiner 108 may comprise at least one token layout component. The at least one token layout component may convert the tokens 104 into a first embedding 202. The first embedding 202 may be an embedding representative of the input audio. The at least one token layout component may convert the tokens 118 into a second embedding 204. The second embedding 204 may be an embedding representative of the target audio. The token combiner 108 may comprise at least one text embedding layer 206. The at least one token layout component may convert the tokens 106 into a third embedding 206. The third embedding 206 may be an embedding representative of the input text 104.

The token combiner 108 may be configured to sum together (e.g., add together) the first embedding 202 and the third embedding 206. The summation of the first embedding 202 and the third embedding 206 may be an audio-text embedding 208. The token combiner 108 may be configured to sum together (e.g., add together) the second embedding 204 and the third embedding 206. The summation of the second embedding 204 and the third embedding 206 may be a target-text embedding 210. The token combiner 108 may comprise a concatenator 112. The concatenator 112 may be configured to concatenate or attach the audio-text embedding 208 and the target-text embedding 210 to generate a continuous embedding 214.

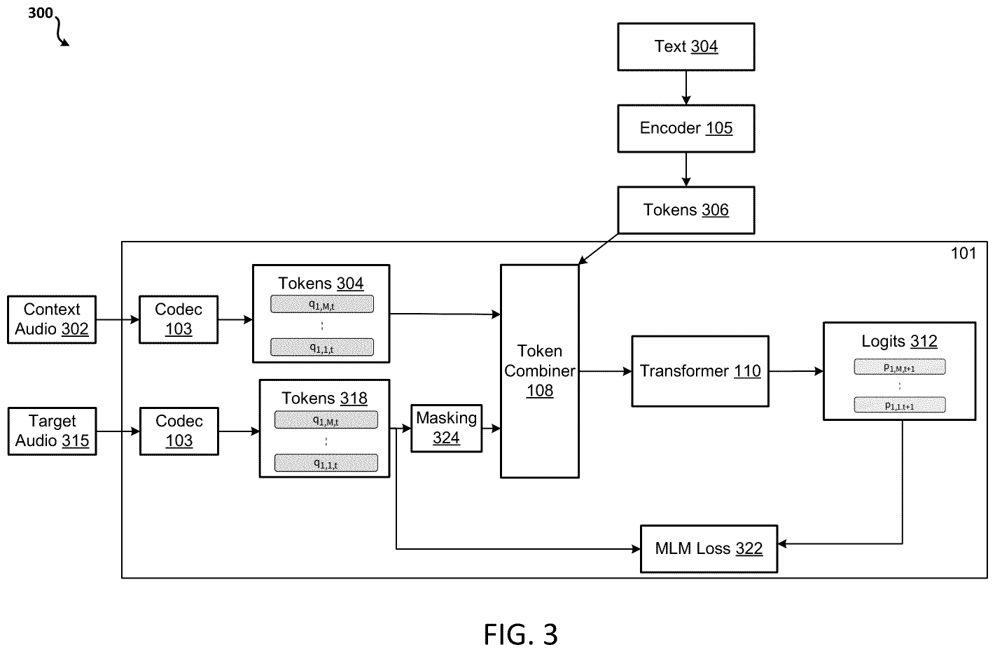

FIG. 3 shows an example system 300 for training the machine learning model 101 to generate target music in accordance with the present disclosure. The machine learning model 101 may be trained on pairs of training data using a masking procedure. Each pair of training data may comprise context audio and ground truth target audio. The masking procedure may comprise masking a portion of the ground truth target audio in any particular pair of training data. The machine learning model 101 may be trained to generate the masked portion of the target audio based on the context audio in the same particular pair of training data.

In an embodiment, a particular pair of training data may comprise context audio 302 and ground truth target audio 315. The context audio 302 and ground truth target audio 315 may be fed into at least one codec 103. The context audio 302 and ground truth target audio 315 may be fed into the same codec or different codecs. The codec(s) may generate a representation of the context audio 302. The representation of the context audio 302 may comprise tokens 304. The tokens 304 may be, for example, a sequence of integer numbers. The codec(s) may generate a representation of the ground truth target audio 315. The representation of the ground truth target audio 315 may comprise tokens 318. The tokens 318 may be, for example, a sequence of integer numbers. The tokens 318 may be input into a masking sub-model 324. The masking sub-model 324 may generate masked target tokens by masking or removing a portion of the tokens 318.

The machine learning model 101 may generate a representation of text 304. The text 304 may specify one or more musical instruments of the ground truth target audio. Additionally, or alternatively, the text 304 may specify one or more of a genre, a tempo, a style, a melody, a rhythm, a pitch, or any other characteristic of the ground truth target audio. The representation of the text 304 may comprise tokens 306. The tokens 306 may be, for example, a sequence of integer numbers. The representation of the input text 304 may be generated using the encoder 105. The encoder 105 may be configured to generate the representation of the text 304 by compressing the text 304 into the tokens 306.

The token combiner 108 may receive, as input, the tokens 304, the masked target tokens, and the tokens 306. The token combiner 108 may be configured to combine the tokens 304, the masked target tokens, and the tokens 306 to generate a continuous embedding (e.g., a set of floating point numbers). The continuous embedding is input into (e.g., received by) the transformer sub-model 110. The transformer sub-model 110 may receive the continuous embedding from the token combiner 108. The transformer sub-model 110 may generate logits 312 based on (e.g., using) the continuous embedding. The logits 312 may comprise predictions of which tokens the machine learning model 101 thinks are in each spot in the masked portion of the tokens 318. The logits 312 may be sent to the masked language model (MLM) loss sub-model 322. The masked language model (MLM) loss sub-model 322 may compare the logits 312 to the ground truth target audio to determine a loss associated with the logits 312. The loss may indicate how bad of a prediction (e.g., how different from ground truth) the logits 312 are. This process may repeat for many iterations until the loss is below a desired threshold.

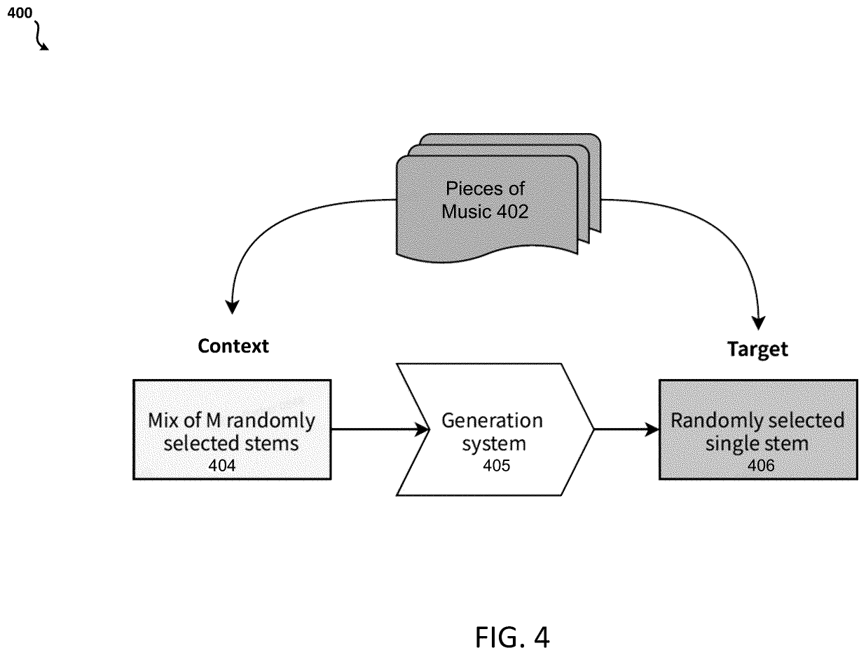

FIG. 4 shows an example system 400 for generating the pairs of training data on which the machine learning model 101 is trained. As described above, each pair of training data comprises context audio and target audio. The pairs of training data may be generated using a plurality of pieces of music 402. Each of the plurality of pieces of music 402 may be separated into M stems, where M represents a positive integer. Each of the M stems may correspond to a musician playing, a particular instrument, or to something more abstract like the output of a sampler or synthesizer.

The context audio in each pair of training data may be generated by randomly selecting N stems from the M stems of one of the plurality of pieces of music 402. N represents a positive integer less than M. The target audio in the same pair of training data may be generated by randomly selecting a remaining stem from the M stems of the same piece of music. For example, the generation system 405 may generate a first pair of training data using a first piece of music. The first piece of music may be separated into five stems. The generation system 405 may randomly select a mix 404 of one, two, three, of four stems from the five stems. The mix 404 of stems may be the context audio in the first pair of training data. The generation system 405 may randomly select one or more remaining stems 406 (e.g., one or more stems that were not randomly selected to generate the context audio). The remaining stem(s) 406 may be the target audio in the first pair of training data. This process may be repeated many times to generate the plurality of pairs of training data. The machine learning model 101 may be trained on the plurality of pairs of training data, such as using the masking procedure described with reference to FIG. 3.

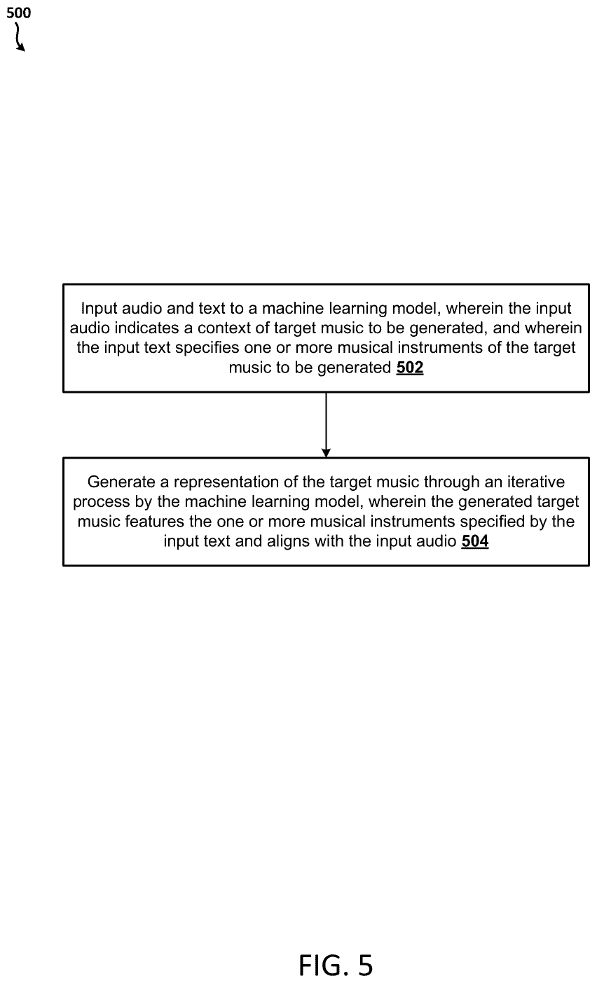

FIG. 5 illustrates an example process 500 for generating target music. Although depicted as a sequence of operations in FIG. 5, those of ordinary skill in the art will appreciate that various embodiments may add, remove, reorder, or modify the depicted operations.

At 502, audio and text may be input to a machine learning model. The input audio may indicate a context of target music to be generated. For example, the input audio may comprise audio of a guitar playing (or any other instrument playing or vocal performance). The input text may specify one or more musical instruments of the target music to be generated. For example, the input text may specify that the target music should include audio of a piano playing (or any other instrument playing or vocal performance). Additionally, or alternatively, the input text may specify one or more of a genre, a tempo, a style, a melody, a rhythm, a pitch, or any other characteristic of the desired target music.

The machine learning model may utilize the input audio and the input text to generate target music that features the one or more musical instruments specified by the input text and aligns with (e.g., corresponds to) the input audio. At 504, a representation of the target music may be generated. The representation of the target music may be generated through an iterative process by the machine learning model. The representation of the target music may comprise tokens (e.g., a sequence of integer numbers) corresponding to the target music. The representation of the target music may be used to generate (e.g., construct, synthesize) the target music. The generated target music may feature the one or more musical instruments specified by the input text and aligns with the input audio. For example, if the input audio comprises audio of a guitar playing and the input text specifies that the target music should include audio of a piano playing, the machine learning model may utilize the input audio and the input text to generate target music that features a piano playing and that aligns with (e.g., corresponds to) the guitar playing.

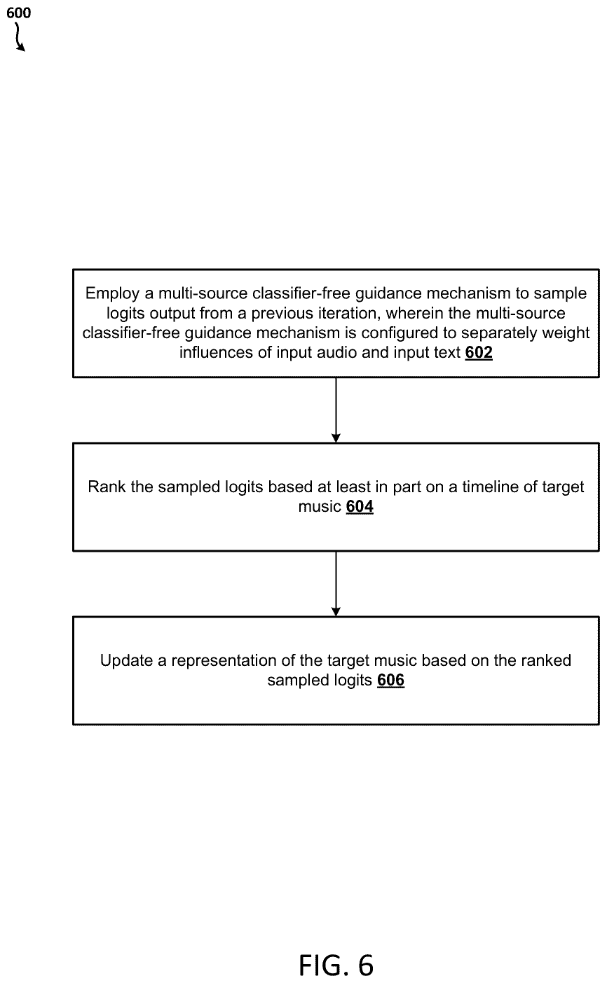

FIG. 6 illustrates an example process 600 for generating target music. Although depicted as a sequence of operations in FIG. 6, those of ordinary skill in the art will appreciate that various embodiments may add, remove, reorder, or modify the depicted operations.

For each of a plurality of iterations, a token combiner may be configured to combine multiple channels of audio information (e.g., one or more of a representation of input audio, a representation of input text, and a representation of target audio) to generate a continuous embedding (e.g., a set of floating point numbers). The continuous embedding is input into (e.g., received by) a transformer sub-model. The transformer sub-model may receive the continuous embedding from the token combiner. The transformer sub-model may generate logits based on (e.g., using) the continuous embedding. The logits may comprise predictions of which tokens the machine learning model thinks are in each spot in the target music that is being generated.

At 602, a multi-source classifier-free guidance mechanism may be employed to sample the logits output from each iteration. The multi-source classifier-free guidance mechanism may be configured to separately weight influences of the input audio and the input text. At 604, the sampled logits may be ranked. The sampled logits may be ranked based at least in part on a timeline of target music. For example, the sampled logits may be ranked using one or more criteria. A first criteria may rank the sampled logits by the confidence of the machine learning model, as indicated by the confidence value of each sampled logit. A second criteria may randomly select the sampled logits, such as by adding Gumbel noise to the confidence rankings with a defined weighting. A third criteria may rank the sampled logits based on a timeline of the target music. For example, the third criteria may encourage earlier sequence elements to be sampled first. Using the third criteria to rank the sampled logits may enforce a kind of fuzzy causality. The third criteria may be used alone, or in combination with the first and/or second criteria, to rank the sampled logits.

The ranked and sampled logits may be used to generate and/or update a representation of the target music. The representation of the target music may comprise tokens (e.g., a sequence of integer numbers). At 606, a representation of the target music may be updated based on the ranked sampled logits. The representation of the target music may be used to generate (e.g., construct, synthesize) the target music. The generated target music may feature the one or more musical instruments specified by the input text and aligns with the input audio.

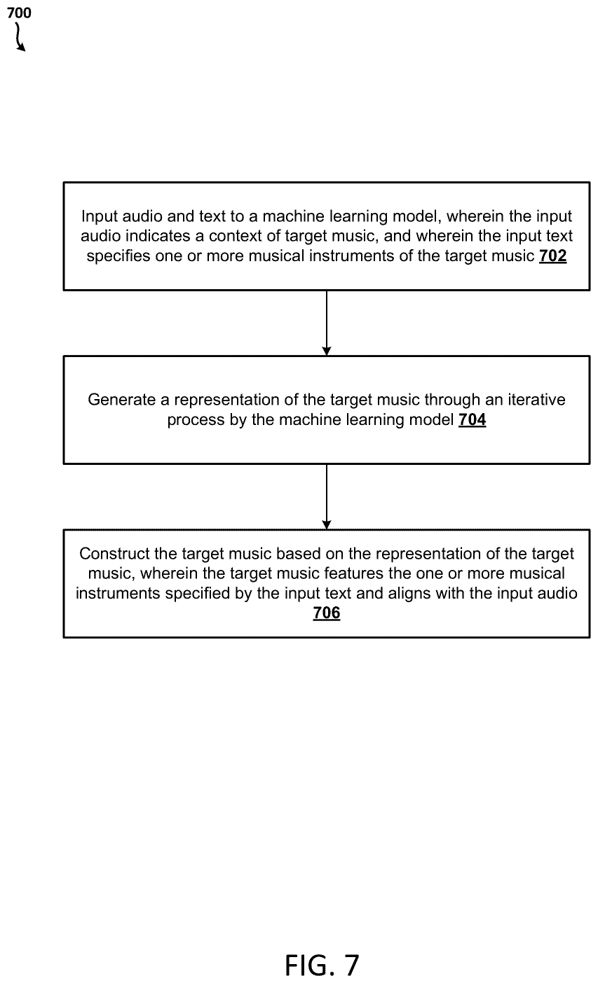

FIG. 7 illustrates an example process 700 for generating target music. Although depicted as a sequence of operations in FIG. 7, those of ordinary skill in the art will appreciate that various embodiments may add, remove, reorder, or modify the depicted operations.

At 702, audio and text may be input to a machine learning model. The input audio may indicate a context of target music to be generated. For example, the input audio may comprise audio of a guitar playing (or any other instrument playing or vocal performance). The input text may specify one or more musical instruments of the target music to be generated. For example, the input text may specify that the target music should include audio of a piano playing (or any other instrument playing or vocal performance). Additionally, or alternatively, the input text may specify one or more of a genre, a tempo, a style, a melody, a rhythm, a pitch, or any other characteristic of the desired target music.

The machine learning model may utilize the input audio and the input text to generate target music that features the one or more musical instruments specified by the input text and aligns with (e.g., corresponds to) the input audio. At 704, a representation of the target music may be generated. The representation of the target music may be generated through an iterative process by the machine learning model. The representation of the target music may comprise tokens (e.g., a sequence of integer numbers) corresponding to the target music.

The representation of the target music may be used to generate (e.g., construct, synthesize) the target music. At 706, the target music may be constructed. The target music may be constructed based on the representation of the target music. The target music may feature the one or more musical instruments specified by the input text and may align with the input audio. For example, if the input audio comprises audio of a guitar playing and the input text specifies that the target music should include audio of a piano playing, the machine learning model may utilize the input audio and the input text to generate target music that features a piano playing and that aligns with (e.g., corresponds to) the guitar playing.

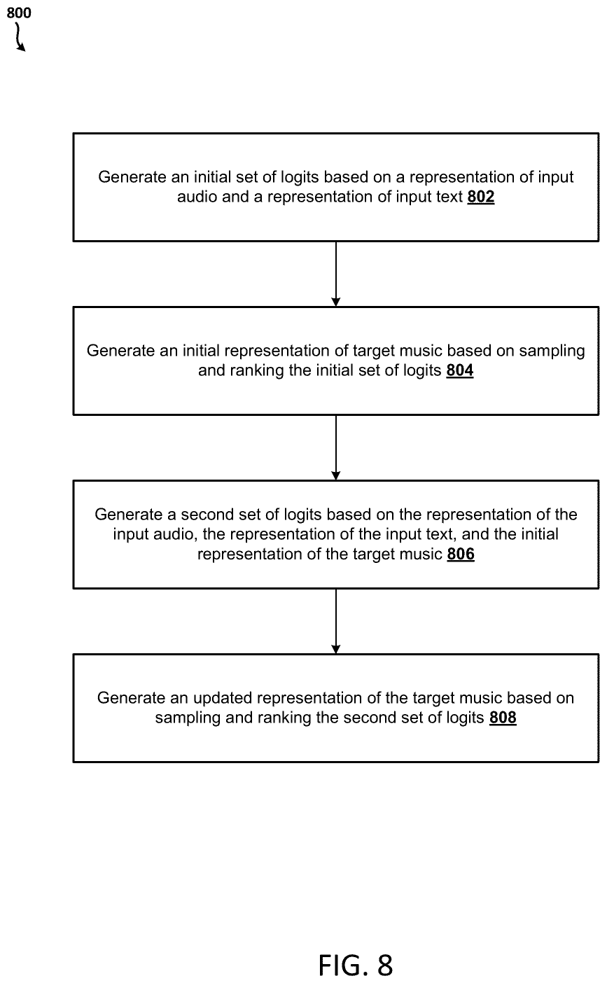

FIG. 8 illustrates an example process 800 for generating target music. Although depicted as a sequence of operations in FIG. 8, those of ordinary skill in the art will appreciate that various embodiments may add, remove, reorder, or modify the depicted operations.

A representation of input audio and a representation of input text may be input into (e.g., received by) a token combiner. The token combiner may be configured to combine the representation of the input audio and the representation of the input text to generate a continuous embedding (e.g., a set of floating point numbers). The continuous embedding may be input into (e.g., received by) a transformer sub-model. At 802, an initial set of logits may be generated. The initial set of logits may be generated by the transformer sub-model. The initial set of logits may be generated based on the representation of input audio and the representation of input text. For example, the initial set of logits may be generated based on the continuous embedding. The initial set of logits may comprise predictions of which tokens are in each spot in the target music that is being generated.

At 804, an initial representation of the target music may be generated. The initial representation of target music may be generated based on sampling and ranking the initial set of logits. The initial set of logits may be sampled by employing a multi-source CFG mechanism. Unlike existing formulations of CFG that only allow for the amplification of the effect (e.g., influence) of one type of external conditioning information on the output of a network, the multi-source CFG mechanism used to sample the initial logits allows for the amplification of the effect (e.g., influence) of multiple types of external conditioning information on the output of a network. For example, the multi-source CFG mechanism may be configured to separately weight the influences of the input audio and the input text on the target music that is being generated. The multi-source CFG can be applied over both conditioning sources simultaneously.

The sampled logits may be ranked using one or more criteria. A first criteria may rank the sampled logits by the confidence of the machine learning model, as indicated by the confidence value of each sampled logit. A second criteria may randomly select the sampled logits, such as by adding Gumbel noise to the confidence rankings with a defined weighting. A third criteria may rank the sampled logits based on a timeline of the target music. For example, the third criteria may encourage earlier sequence elements to be sampled first. Using the third criteria to rank the sampled logits may enforce a kind of fuzzy causality. The third criteria may be used alone, or in combination with the first and/or second criteria, to rank the sampled logits. The ranked and sampled logits may be used to generate the initial representation of the target music. The initial representation of the target music may comprise tokens. The tokens may be, for example, a sequence of integer numbers.

The input audio, the representation of the input text, and the initial representation of the target music may be input into the token combiner. The token combiner may be configured to combine the representation of the input audio, the representation of the input text, and the initial representation of the target music to generate a continuous embedding (e.g., a set of floating point numbers). The continuous embedding may be input into (e.g., received by) the transformer sub-model 110. The transformer sub-model 110 may receive the continuous embedding from the token combiner. At 806, a second set of logits may be generated. The second set of logits may be generated based on the representation of the input audio, the representation of the input text, and the initial representation of the target music. For example, the transformer sub-model may generate the second set of logits based on (e.g., using) the continuous embedding. The second set of logits may comprise updated predictions of which tokens the machine learning model thinks are in each spot in the target music that is being generated.

At 808, an updated representation of the target music may be generated. The updated representation of the target music may be generated based on sampling and ranking the second set of logits. The second set of logits may be sampled by employing the multi-source CFG mechanism. The sampled logits from the second set of logits may be ranked. The sampled logits from the second set of logits may be ranked using the one or more criteria described above (e.g., confidence, random selection, and/or earlier sequence elements). The ranked and sampled logits may be used to generate an updated (e.g., second) representation of the target music. For example, the second representation of the target music may comprise updated tokens.

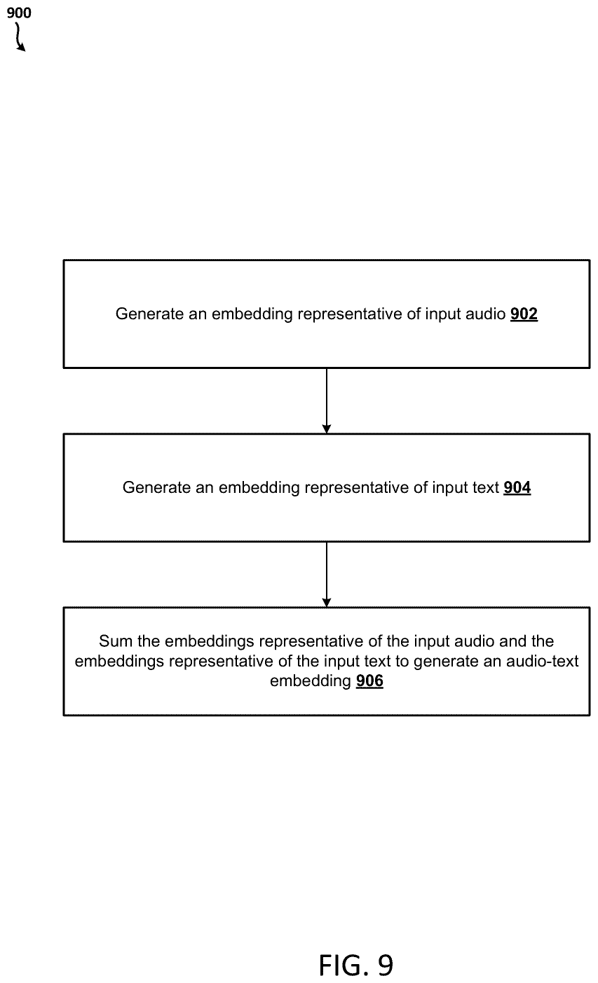

FIG. 9 illustrates an example process 900 for generating an audio-text embedding. Although depicted as a sequence of operations in FIG. 9, those of ordinary skill in the art will appreciate that various embodiments may add, remove, reorder, or modify the depicted operations.

A token combiner may be configured to combine multiple channels of audio information to generate a continuous embedding (e.g., a set of floating point numbers). The token combiner may receive, as input, tokens associated with input audio. At 902, an embedding representative of input audio may be generated. For example, the token combiner may comprise at least one token layout component. The at least one token layout component may convert the tokens associated with the input audio into the embedding representative of the input audio. The token combiner may receive, as input tokens associated with input text. At 904, an embedding representative of the input text may be generated. For example, the at least one token layout component may convert the tokens associated with the input text into the embedding representative of the input text. The token combiner may be configured to sum together (e.g., add together) the embedding representative of the input audio and the embedding representative of the input text. At 906, the embeddings representative of the input audio and the embeddings representative of the input text may be summed to generate an audio-text embedding.

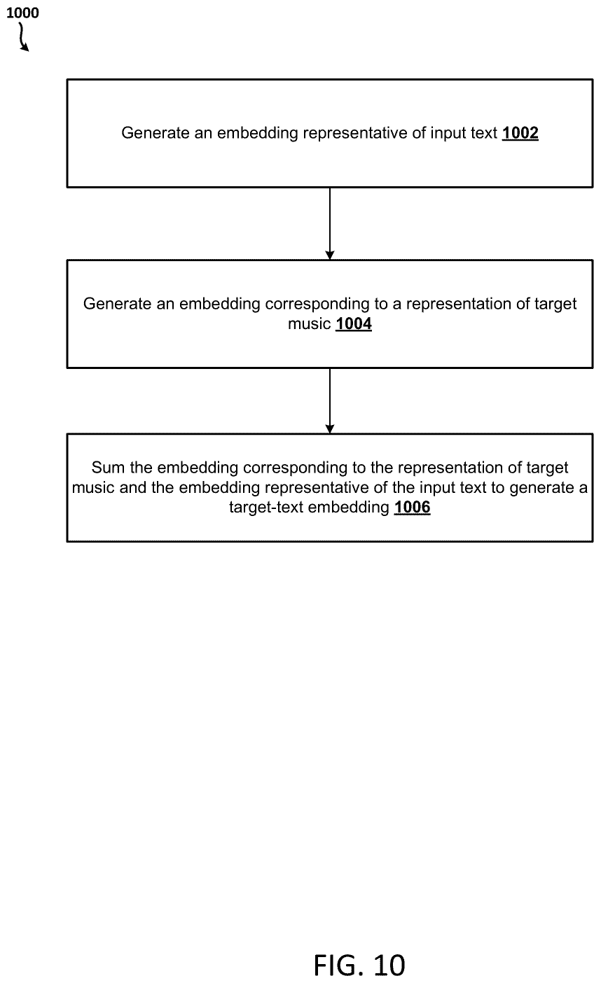

FIG. 10 illustrates an example process 1000 for generating a target-text embedding. Although depicted as a sequence of operations in FIG. 10, those of ordinary skill in the art will appreciate that various embodiments may add, remove, reorder, or modify the depicted operations.

A token combiner may be configured to combine multiple channels of audio information to generate a continuous embedding (e.g., a set of floating point numbers). The token combiner may receive, as input, tokens associated with input text. At 1002, an embedding representative of the input text may be generated. For example, the token combiner may comprise at least one token layout component configured to convert the tokens associated with input text into the embedding representative of the input text. The token combiner may receive, as input, tokens associated with target music. At 1002, an embedding representative of the target music may be generated. For example, the token combiner may comprise at least one token layout component. The at least one token layout component may convert the tokens associated with the target music into the embedding representative of the target music. The token combiner may be configured to sum together (e.g., add together) the embedding representative of the target music and the embedding representative of the input text. At 1006, the embeddings representative of the target music and the embeddings representative of the input text may be summed to generate a target-text embedding.

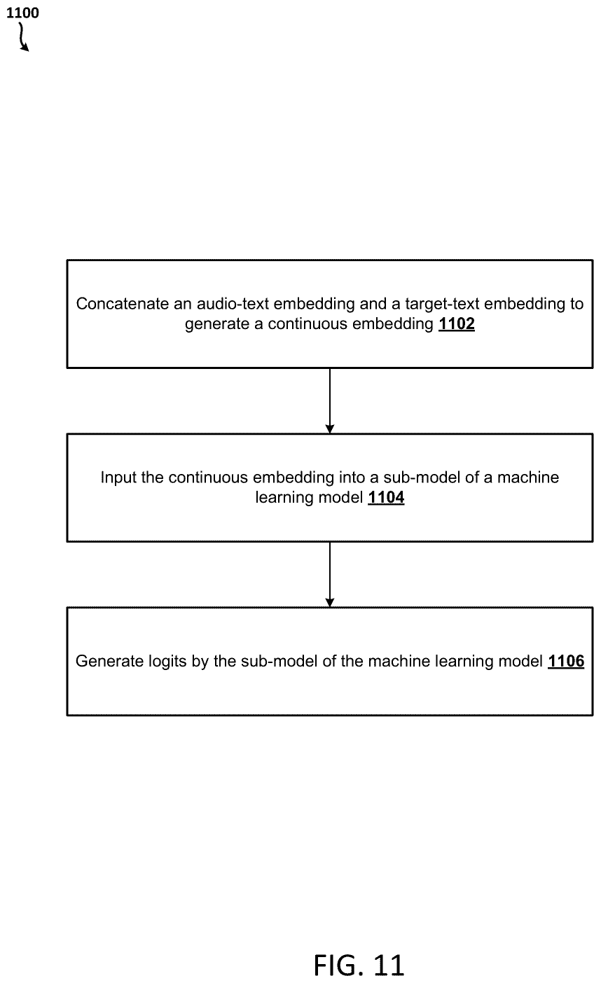

FIG. 11 illustrates an example process 1100 for generating continuous embeddings and generating logits in accordance with the present disclosure. Although depicted as a sequence of operations in FIG. 11, those of ordinary skill in the art will appreciate that various embodiments may add, remove, reorder, or modify the depicted operations.

A token combiner may be configured to sum together (e.g., add together) an embedding representative of context audio and an embedding representative of input text to generate a target-text embedding. The token combiner may be configured to sum together (e.g., add together) an embedding representative of target music and the embedding representative of input text to generate a target-text embedding. At 1102, the audio-text embedding and the target-text embedding may be concatenated. The audio-text embedding and the target-text embedding may be concatenated to generate a continuous embedding. At 1104, the continuous embedding may be input into a sub-model of a machine learning model. At 1106, logits may be generated by the sub-model of the machine learning model. The logits may be generated by the sub-model based on the continuous embedding. The logits may comprise predictions of which tokens the machine learning model determines are in each spot of the target music that is being generated.

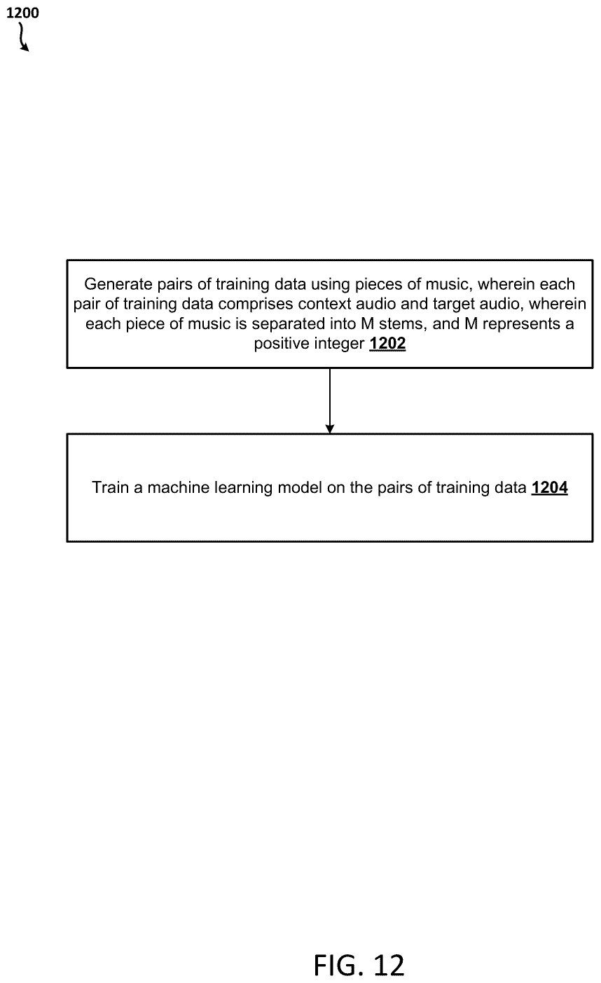

FIG. 12 illustrates an example process 1200 for training a machine learning model to generate target music in accordance with the present disclosure. Although depicted as a sequence of operations in FIG. 12, those of ordinary skill in the art will appreciate that various embodiments may add, remove, reorder, or modify the depicted operations.

At 1202, pairs of training data may be generated. The pairs of training data may be generated using pieces of music. Each piece of music may be separated into M stems, where M represents a positive integer. Each pair of training data may comprise context audio and target audio. For example, the context audio in each pair may comprise a randomly selected subset N of the M stems associated with a particular piece of music. The context audio in each pair may comprise at last one randomly selected stem from the remaining M-N stems. At 1204, a machine learning model may be trained on the pairs of training data. The machine learning model may be trained to generate target music based on input text and input context audio.

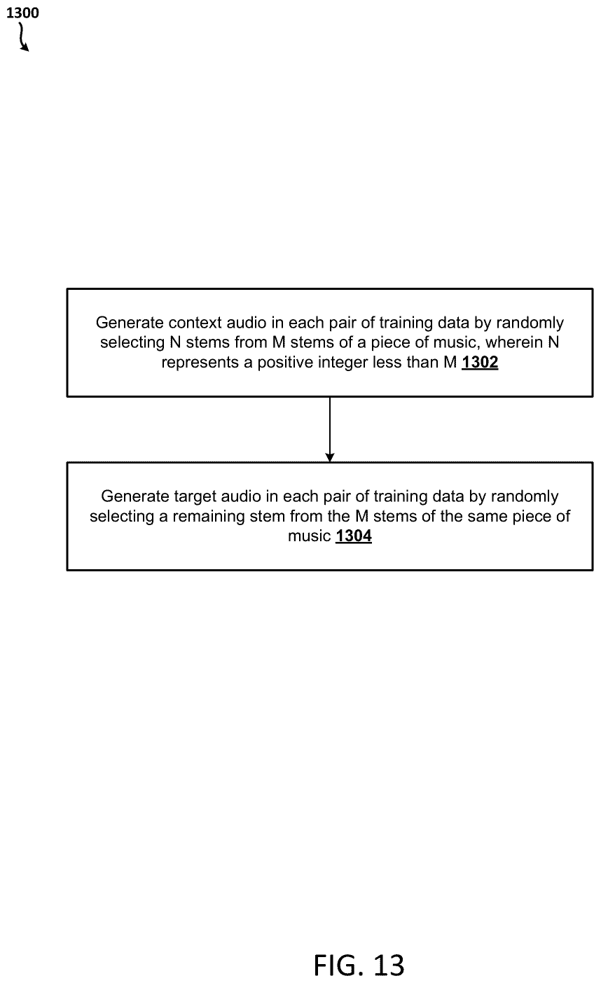

FIG. 13 illustrates an example process 1300 for generating pairs of training data. Although depicted as a sequence of operations in FIG. 13, those of ordinary skill in the art will appreciate that various embodiments may add, remove, reorder, or modify the depicted operations.

As described above, each pair of training data comprises context audio and target audio. The pairs of training data may be generated using a plurality of pieces of music. Each of the plurality of pieces of music may be separated into M stems, where M represents a positive integer. Each of the M stems may correspond to a musician playing, a particular instrument, or to something more abstract like the output of a sampler or synthesizer. At 1302, context audio in each pair of training data may be generated. The context audio in each pair of training data may be generated by randomly selecting N stems from M stems of a piece of music, wherein N represents a positive integer less than M. At 1304, target audio in each pair of training data may be generated. The target audio in each pair of training data may be generated by randomly selecting a remaining stem from the M stems of the same piece of music.

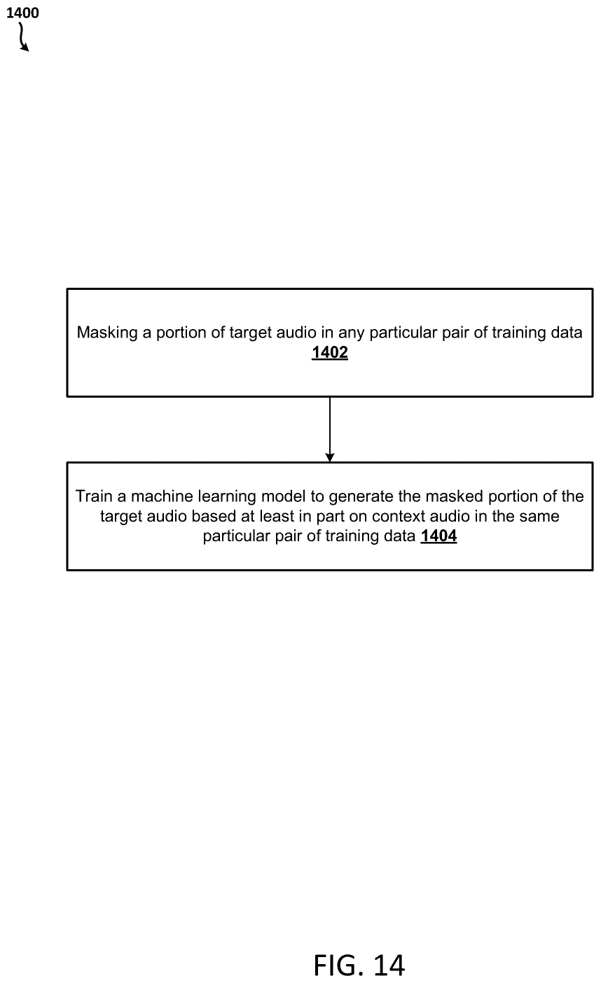

FIG. 14 illustrates an example process 1400 for training a machine learning model to generate target music. Although depicted as a sequence of operations in FIG. 14, those of ordinary skill in the art will appreciate that various embodiments may add, remove, reorder, or modify the depicted operations.

A machine learning model may be trained to generate target music on pairs of training data using a masking procedure. Each pair of training data may comprise context audio and ground truth target audio. A representation of the context audio in any particular pair of training data may be generated. The representation of the context audio may comprise tokens (e.g., a sequence of integer numbers). A representation of the target audio in the same particular pair of training data may be generated. The representation of the target audio may comprise tokens (e.g., a sequence of integer numbers). The representation of the target audio may be input into a masking sub-model. At 1402, a portion of the target audio may be masked. For example, the masking sub-model may generate a masked representation (e.g., masked target tokens) by masking the portion of target audio.

At 1404, a machine learning model may be trained to generate the masked portion of the target audio. The machine learning model may be trained to generate the masked portion of the target audio based at least in part on the context audio in the same particular pair of training data. For example, a representation of text may be generated. The text may specify one or more musical instruments of the ground truth target audio. Additionally, or alternatively, the text may specify one or more of a genre, a tempo, a style, a melody, a rhythm, a pitch, or any other characteristic of the ground truth target audio. The representation of the text, the representation of the context audio, and the masked representation of the target audio may be used to generate logits. The logits may comprise predictions of what the machine learning model determines is in each spot of the masked portion of the target audio. A masked language model (MLM) loss sub-model may compare the logits to the ground truth target audio to determine a loss associated with the logits. The loss may indicate how bad of a prediction (e.g., how different from ground truth) the logits are. This process may repeat for many iterations until the loss is below a desired threshold.

The machine learning model 101 was evaluated. The machine learning model 101 trained on a first dataset consisting of 145 hours of synthetic musical audio separated into stems was evaluated. Additionally, the machine learning model 101 trained on a second dataset of 500 hours of licensed human-played music separated into stems was evaluated. For evaluation, sets of 400 example outputs were produced following a similar procedure to that used for the construction of training examples shown in FIG. 4, but pulling from a separate set of test data not contained within the training set. For each example, a context-mix was generated, and a target-stem category was randomly selected. The generated stem produced by the model for this set of conditioning was placed into one population. The real stem for the matching target category was placed into another population. These two populations were then compared with a variety of metrics. This procedure ensured there was no systematic error introduced by an imbalance in target categories between the two populations. FAD-type metrics were calculated between the two populations of isolated stems, whereas MIRDD was calculated on modified populations consisting of stems summed with their original context-mix. This allowed the MIRDD metric to better penalize poor musical alignment and coherence.

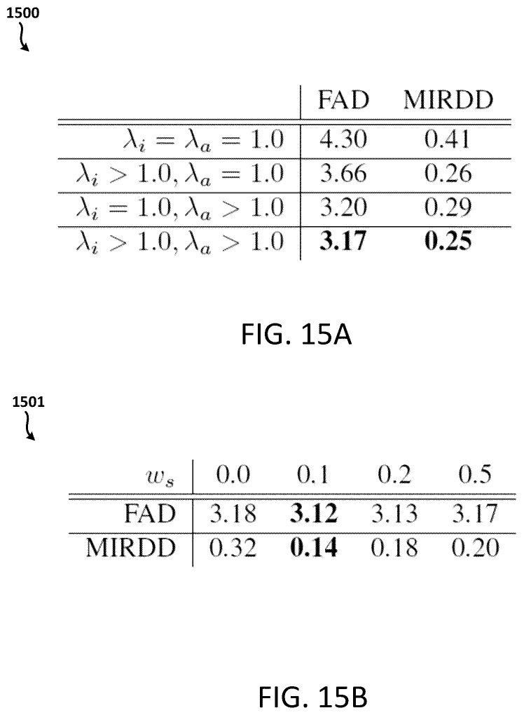

In order to evaluate the performance of the causal-bias during iterative decoding, two ablations were performed. For these ablations, the model trained on the first dataset was used. Firstly, the impact of multi-source classifier-free-guidance was tested by calculating metrics over a variety of guidance scales, λₐ and λᵢ, with respect to the two conditioning sources cₐ and cᵢ. The results can be seen in table 1500 of FIG. 15A. Table 1500 shows averaged objective metrics with different ranges of guidance scales. A value of 1.0 for guidance scale is equivalent to no guidance with respect to that conditioning source. The exact best values for guidance scale are very dependent on the conditioning information, so for cases where the guidance scale is greater than 1.0 results averaged over 1000 examples are shown at different values of λᵢ, λₐ up to a maximum of 4.0. The results confirm that adding guidance over multiple sources is beneficial. λₐ=λᵢ=3.0 was settled on as a general setting for evaluation.

Secondly, the impact of causal bias during iterative decoding was tested by comparing various relative strengths of causal bias. The other ranking weights, w_{c} and wᵣ were set to 0.1 and 1.0 respectively. The results can be seen in table 1501 of FIG. 15B. Table 1501 shows objective evaluation metrics for various values of causal-bias weight wₛ. Table 1501 shows that adding a small amount of causal-bias has a positive effect on FAD and MIRDD metrics, indicating an increase in sound quality and musical alignment. This lessens as wₛ increases further. Therefore, wₛ=0.1 was used for further experiments. During iterative decoding, 128, 64, 32 and 32 steps were used, respectively, for the four hierarchical levels of the tokenizer.

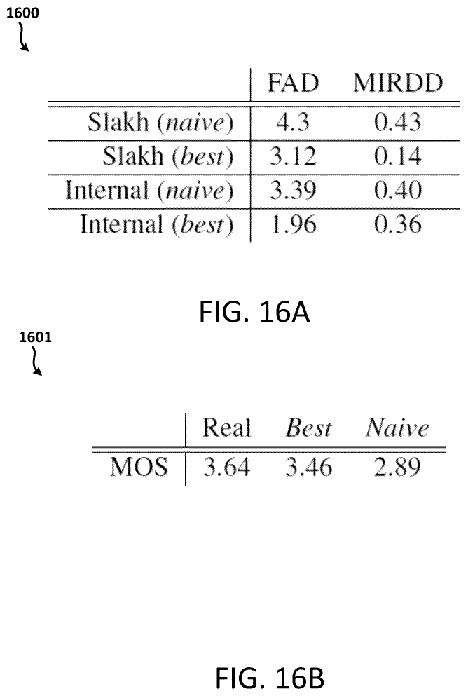

The model trained on the first dataset, and the model trained on the second dataset were both evaluated. Both models were sampled from using the sampling techniques described herein. Additionally, each model was sampled from using a set of naive sampling parameters, which are equivalent to removing classifier-free-guidance and causal-bias in decoding. Objective metrics for these sets of outputs in table 1600 of FIG. 16A. Table 1600 shows objective evaluation metrics for both models with best and naive sampling parameters. Whilst a direct comparison is not possible due to the different task, the FAD scores for the models trained on both the first dataset and the second dataset are comparable to those seen for state-of-the-art text-conditioned models. It is also clear that the larger size and human-content of the second dataset leads to an appreciable improvement in output quality.

A Mean Opinion Score (MOS) test was also conducted by asking ten participants with music training to verify the subjective quality of the produced model. Three sets of outputs were constructed by mixing generated or real stems with their corresponding context-mix. The generated stems were taken from the naive and best sets of output from the model trained on the second dataset as evaluated in the table 1600. The real stems were taken from the references sets used for previous evaluations. A set of 60 mixes was collated using this technique (equally split between naive, best and real) and listeners were asked to rate the overall quality on a scale from very bad (1) to very good (5). The results are shown in table 1601 of FIG. 16B. The results shown in the table 1601 confirm that the proposed model is capable of creating plausible musical outcomes.

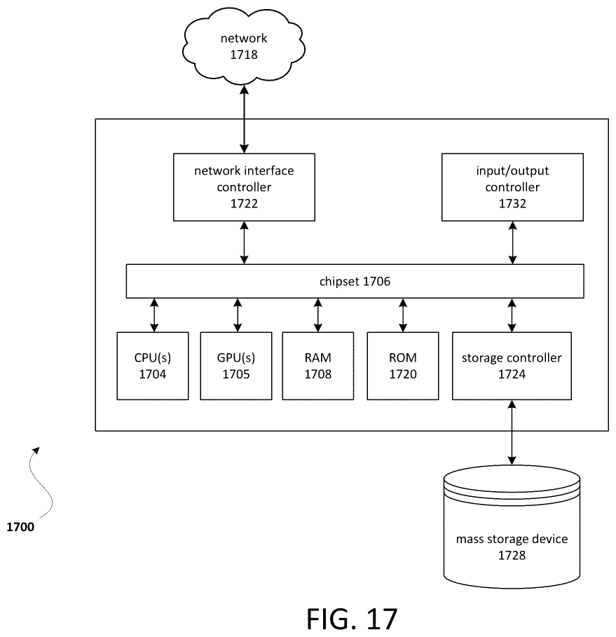

FIG. 17 illustrates a computing device that may be used in various aspects, such as the services, networks, modules, and/or devices depicted in any of FIGS. 1-4. With regard to FIGS. 1-4, any or all of the components may each be implemented by one or more instance of a computing device 1700 of FIG. 17. The computer architecture shown in FIG. 17 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1700 may include a baseboard, or “motherboard,” which is a printed circuit board to which a multitude of components or devices may be connected by way of a system bus or other electrical communication paths. One or more central processing units (CPUs) 1704 may operate in conjunction with a chipset 1706. The CPU(s) 1704 may be standard programmable processors that perform arithmetic and logical operations necessary for the operation of the computing device 1700.

The CPU(s) 1704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1704 may be augmented with or replaced by other processing units, such as GPU(s) 1705. The GPU(s) 1705 may comprise processing units specialized for but not necessarily limited to highly parallel computations, such as graphics and other visualization-related processing.

A chipset 1706 may provide an interface between the CPU(s) 1704 and the remainder of the components and devices on the baseboard. The chipset 1706 may provide an interface to a random-access memory (RAM) 1708 used as the main memory in the computing device 1700. The chipset 1706 may further provide an interface to a computer-readable storage medium, such as a read-only memory (ROM) 1720 or non-volatile RAM (NVRAM) (not shown), for storing basic routines that may help to start up the computing device 1700 and to transfer information between the various components and devices. ROM 1720 or NVRAM may also store other software components necessary for the operation of the computing device 1700 in accordance with the aspects described herein.

The computing device 1700 may operate in a networked environment using logical connections to remote computing nodes and computer systems through local area network (LAN). The chipset 1706 may include functionality for providing network connectivity through a network interface controller (NIC) 1722, such as a gigabit Ethernet adapter. A NIC 1722 may be capable of connecting the computing device 1700 to other computing nodes over a network 1716. It should be appreciated that multiple NICs 1722 may be present in the computing device 1700, connecting the computing device to other types of networks and remote computer systems.

The computing device 1700 may be connected to a mass storage device 1728 that provides non-volatile storage for the computer. The mass storage device 1728 may store system programs, application programs, other program modules, and data, which have been described in greater detail herein. The mass storage device 1728 may be connected to the computing device 1700 through a storage controller 1724 connected to the chipset 1706. The mass storage device 1728 may consist of one or more physical storage units. The mass storage device 1728 may comprise a management component 1710. A storage controller 1724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1700 may store data on the mass storage device 1728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1728 is characterized as primary or secondary storage and the like.

For example, the computing device 1700 may store information to the mass storage device 1728 by issuing instructions through a storage controller 1724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1700 may further read information from the mass storage device 1728 by detecting the physical states or characteristics of one or more particular locations within the physical storage units.

In addition to the mass storage device 1728 described above, the computing device 1700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1728 depicted in FIG. 17, may store an operating system utilized to control the operation of the computing device 1700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1728 may store other system or application programs and data utilized by the computing device 1700.

The mass storage device 1728 or other computer-readable storage media may also be encoded with computer-executable instructions, which, when loaded into the computing device 1700, transforms the computing device from a general-purpose computing system into a special-purpose computer capable of implementing the aspects described herein. These computer-executable instructions transform the computing device 1700 by specifying how the CPU(s) 1704 transition between states, as described above. The computing device 1700 may have access to computer-readable storage media storing computer-executable instructions, which, when executed by the computing device 1700, may perform the methods described herein.

A computing device, such as the computing device 1700 depicted in FIG. 17, may also include an input/output controller 1732 for receiving and processing input from a number of input devices, such as a keyboard, a mouse, a touchpad, a touch screen, an electronic stylus, or other type of input device. Similarly, an input/output controller 1732 may provide output to a display, such as a computer monitor, a flat-panel display, a digital projector, a printer, a plotter, or other type of output device. It will be appreciated that the computing device 1700 may not include all of the components shown in FIG. 17, may include other components that are not explicitly shown in FIG. 17, or may utilize an architecture completely different than that shown in FIG. 17.

As described herein, a computing device may be a physical computing device, such as the computing device 1700 of FIG. 17. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method for generating target music using a machine learning model, comprising:
inputting audio and text to the machine learning model, wherein the input audio indicates a context of the target music, and wherein the input text specifies one or more musical instruments of the target music; and
generating a representation of the target music through an iterative process, wherein the target music features the one or more musical instruments specified by the input text and aligns with the input audio, and wherein the iterative process comprises a plurality of iterations each of which comprises:
employing a multi-source classifier-free guidance mechanism to sample logits output from a previous iteration, wherein the multi-source classifier-free guidance mechanism is configured to separately weight influences of the input audio and the input text,
ranking the sampled logits based at least in part on a timeline of the target music, and
updating the representation of the target music based on the ranked sampled logits.

2. The method of claim 1, further comprising:
constructing the target music based on the representation of the target music.

3. The method of claim 1, further comprising:
generating an initial set of logits based on a representation of the input audio and a representation of the input text; and
generating an initial representation of the target music based on sampling and ranking the initial set of logits.

4. The method of claim 3, further comprising:
generating a second set of logits based on the representation of the input audio, the representation of the input text, and the initial representation of the target music.

5. The method of claim 4, further comprising:
generating an updated representation of the target music based on sampling and ranking the second set of logits.

6. The method of claim 1, further comprising:
generating an embedding representative of the input audio;
generating an embedding representative of the input text; and
summing the embedding representative of the input audio and the embedding representative of the input text to generate an audio-text embedding.

7. The method of claim 6, further comprising:
generating an embedding corresponding to the representation of target music; and
summing the embedding corresponding to the representation of target music and the embedding representative of the input text to generate a target-text embedding.

8. The method of claim 7, further comprising:
concatenating the audio-text embedding and the target-text embedding to generate a continuous embedding;
inputting the continuous embedding into a sub-model of the machine learning model; and
generating the logits by the sub-model.

9. The method of claim 1, wherein the text specifies at least one of a genre, a tempo, a style, a melody, a rhythm, or a pitch of the target music.

10. The method of claim 1, further comprising:
generating pairs of training data using pieces of music, wherein each pair of training data comprises context audio and target audio, wherein each piece of music is separated into M stems, and M represents a positive integer.

11. The method of claim 10, further comprising:
generating the context audio in each pair by randomly selecting N stems from the M stems of one of the pieces of music, wherein N represents a positive integer less than M; and
generating the target audio in each pair by randomly selecting a remaining stem from the M stems of the one of the pieces of music.

12. The method of claim 10, further comprising:
training the machine learning model on the pairs of training data using a masking procedure, wherein the masking procedure comprises:
masking a portion of the target audio in any particular pair of training data, and
training the machine learning model to generate the masked portion of the target audio based on the context audio in the same particular pair of training data.

13. A system for generating target audio using a machine learning model, comprising:
at least one processor; and
at least one memory communicatively coupled to the at least one processor and comprising computer-readable instructions that upon execution by the at least one processor cause the at least one processor to perform operations comprising:
inputting audio and text to the machine learning model, wherein the input audio indicates a context of the target music, and wherein the input text specifies one or more musical instruments of the target music; and
generating a representation of the target music through an iterative process, wherein the target music features the one or more musical instruments specified by the input text and aligns with the input audio, and wherein the iterative process comprises a plurality of iterations each of which comprises:
employing a multi-source classifier-free guidance mechanism to sample logits output from a previous iteration, wherein the multi-source classifier-free guidance mechanism is configured to separately weight influences of the input audio and the input text,
ranking the sampled logits based at least in part on a timeline of the target music, and
updating the representation of the target music based on the ranked sampled logits.

14. The system of claim 13, the operations further comprising:
generating an initial set of logits based on a representation of the input audio and a representation of the input text; and
generating an initial representation of the target music based on sampling and ranking the initial set of logits;
generating a second set of logits based on the representation of the input audio, the representation of the input text, and the initial representation of the target music; and
generating an updated representation of the target music based on sampling and ranking the second set of logits.

15. The system of claim 13, the operations further comprising:
generating pairs of training data using pieces of music, wherein each pair of training data comprises context audio and target audio, wherein each piece of music is separated into M stems, and M represents a positive integer.

16. The system of claim 15, the operations further comprising:
generating the context audio in each pair by randomly selecting N stems from the M stems of one of the pieces of music, wherein N represents a positive integer less than M; and
generating the target audio in each pair by randomly selecting a remaining stem from the M stems of the one of the pieces of music.

17. A non-transitory computer-readable storage medium, storing computer-readable instructions that upon execution by a processor cause the processor to implement operations comprising:
inputting audio and text to the machine learning model, wherein the input audio indicates a context of the target music, and wherein the input text specifies one or more musical instruments of the target music; and
generating a representation of the target music through an iterative process, wherein the target music features the one or more musical instruments specified by the input text and aligns with the input audio, and wherein the iterative process comprises a plurality of iterations each of which comprises:
employing a multi-source classifier-free guidance mechanism to sample logits output from a previous iteration, wherein the multi-source classifier-free guidance mechanism is configured to separately weight influences of the input audio and the input text,
ranking the sampled logits based at least in part on a timeline of the target music, and
updating the representation of the target music based on the ranked sampled logits.

18. The non-transitory computer-readable storage medium of claim 17, the operations further comprising:
generating an initial set of logits based on a representation of the input audio and a representation of the input text; and
generating an initial representation of the target music based on sampling and ranking the initial set of logits;
generating a second set of logits based on the representation of the input audio, the representation of the input text, and the initial representation of the target music; and
generating an updated representation of the target music based on sampling and ranking the second set of logits.

19. The non-transitory computer-readable storage medium of claim 17, the operations further comprising:
generating pairs of training data using pieces of music, wherein each pair of training data comprises context audio and target audio, wherein each piece of music is separated into M stems, and M represents a positive integer.

20. The non-transitory computer-readable storage medium of claim 19, the operations further comprising:
generating the context audio in each pair by randomly selecting N stems from the M stems of one of the pieces of music, wherein N represents a positive integer less than M; and
generating the target audio in each pair by randomly selecting a remaining stem from the M stems of the one of the pieces of music.
